(19) United States
(12) Patent Application Publication
(10) Pub. No.: US 2008/0240117 A1
(43) Pub. Date: Oct. 2, 2008

(54) System, Method, and Interworking Function for Interfacing MMS and IMS Messaging Systems

(75) Inventors: Edoardo Gavita, Laval (CA); Bernhard Meier, St. Lazare (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/694,470

(22) Filed: Mar. 30, 2007

(51) Int. Cl. H04L 12/28

(52) U.S. Cl. 370/400

(57) ABSTRACT

A system, method, and interworking function for interfacing the Multimedia Messaging Service (MMS) and IP Multimedia Subsystem (IMS) messaging systems. When an Multimedia Messaging Service Center (MMSC) receives an MMS message, the MMSC determines whether the message is addressed to an MMS user or an IMS user. If addressed to an MMS user, the MMSC routes the MMS message to an email server for forwarding to another MMSC. If addressed to an IMS user, the MMSC routes the MMS message to the interworking function. The interworking function converts a destination address in the MMS message to a destination address for the IMS user that is routable through a Session Initiation Protocol (SIP) core network. The message may be mapped to a SIP MESSAGE format or an MSRP format and sent through the SIP core network to the addressed IMS user.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to radio telecommunication systems. More particularly, and not by way of limitation, the invention is directed to a system, method, and interworking function for interfacing the Multimedia Messaging Service (MMS) and the IP Multimedia Subsystem (IMS) messaging systems.

MMS is a standard telephony messaging system that enables users to send messages that includes multimedia objects (for example, images, audio, video, or rich text) in addition to plain text messages as in the earlier developed Short Message Service (SMS). MMS is mainly deployed in cellular networks along with other messaging systems like SMS, Mobile Instant Messaging, and Mobile E-Mail. The MMS addressing scheme utilizes ISDN or E.164 numbers (for example, 0015143457900) in the TO and FROM fields of packet headers.

IMS is an architectural framework originally designed by the Third Generation Partnership Project (3GPP) for evolving mobile networks beyond GSM and delivering IP multimedia services to end users. In its original form, IMS provided an approach for delivering “Internet Services” over GPRS. This vision was subsequently updated by 3GPP, 3GPP2, and TISPAN by providing requirements for support of networks other than GPRS such as Wireless LAN, CDMA2000, and Fixed Line.

To ease the integration with the Internet, the IMS as far as possible utilizes Internet Engineering Task Force (IETF) protocols such as the Session Initiation Protocol (SIP). Therefore, the IMS addressing scheme uses SIP Uniform Resource Identifiers (URIs) (for example, sip:usera@domain1.com) in the TO and FROM fields of packet headers. A problem arises, therefore, when an IMS user and an MMS user desire to communicate because the MMS addressing scheme is not compatible with the IMS addressing scheme. There is presently no known solution for making these addressing schemes compatible.

What is needed in the art is a system, method, and interworking function for interfacing the Multimedia Messaging Service (MMS) and the IP Multimedia Subsystem (IMS), thereby enabling IMS and MMS messages to be transported to users in the other system. The present invention provides such a system, method, and interworking function.

### BRIEF SUMMARY OF THE INVENTION

The present invention enables the sending of IMS messages to MMS users and the sending of MMS messages to IMS users between two different operator domains. Installed Multimedia Messaging Service Centers (MMSCs) can be upgraded with the present invention to interwork with IMS systems.

Thus, in one aspect, the present invention is directed to a system for providing interoperability between the Multimedia Messaging Service (MMS) and the IP Multimedia Subsystem (IMS). The system includes logic within a multimedia messaging service center for determining whether a received MMS message includes an indication that the MMS message is destined for an IMS user; and routing logic within the multimedia messaging service center for selectively routing the MMS message to either an email server or an interworking function. The MMS message is routed to the email server if the MMS message does not include an indication that the MMS message is destined for an IMS user, and the MMS message is routed to the interworking function if the MMS message includes an indication that the MMS message is destined for an IMS user. The system also includes logic within the interworking function for converting a destination address in the MMS message to a destination address for the IMS user that is routable through a Session Initiation Protocol (SIP) core network; and an output interface for sending the converted MMS message to the SIP core network for routing to the IMS user.

The interworking function may also include an input interface for receiving through the SIP core network, an IMS message destined for an MMS user; mapping logic for converting a source address of the received IMS message from a SIP address to an MMS address; and a second output interface for sending the converted IMS message to the multimedia messaging service center for forwarding to the MMS user.

In another aspect, the present invention is directed to a method of interfacing the MMS and the IMS messaging systems. The method includes the steps of determining within a multimedia messaging service center whether a received MMS message includes an indication that the MMS message is destined for an IMS user; and selectively routing the MMS message from the multimedia messaging service center to either an email server or an interworking function, wherein the MMS message is routed to the email server if the MMS message does not include an indication that the MMS message is destined for an IMS user, and the MMS message is routed to the interworking function if the MMS message includes an indication that the MMS message is destined for an IMS user. The method also includes converting by the interworking function, a destination address in the MMS message to a destination address for the IMS user that is routable through a Session Initiation Protocol (SIP) core network; and sending the converted MMS message from the interworking function to the SIP core network for routing to the IMS user.

In another aspect, the present invention is directed to a multimedia messaging service center for providing seamless communications between MMS users and IMS users. The multimedia messaging service center includes address resolution logic for determining whether a received MMS message is addressed to a destination MMS user or a destination IMS user; and routing logic for selectively routing the MMS message to the destination MMS user or the destination IMS user based on a determination by the address resolution logic.

The address resolution logic may include logic for detecting an indication that the destination address is not in standard MMS format, and logic for detecting a SIP prefix prior to a destination address in a TO field of the received MMS message, wherein the SIP prefix indicates the MMS message is addressed to a destination IMS user. The routing logic is adapted to route the MMS message to a SIP core network when the address resolution logic detects the SIP prefix. The multimedia messaging service center may also include logic for selectively mapping the MMS message to either a SIP MESSAGE format or a Message Session Relay Protocol (MSRP) format when the MMS message is routed to the SIP core network.

### BRIEF DESCRIPTION OF THE SEVERAL VIEWS OF THE DRAWING

In the following, the essential features of the invention will be described in detail by showing preferred embodiments, with reference to the attached figure in which:

FIG. 1 is a simplified block diagram of an exemplary embodiment of the system and interworking function of the present invention, and showing an exemplary message flow in an embodiment of the method of the present invention;

FIG. 2 is a message flow diagram illustrating the flow of messages in an exemplary embodiment of the method of the present invention;

FIG. 3 is a message flow diagram illustrating the flow of messages in another exemplary embodiment of the method of the present invention; and

FIG. 4 is a flow chart illustrating the steps of an exemplary embodiment of the method of the present invention.

### DETAILED DESCRIPTION OF THE INVENTION

In one embodiment, the present invention is an MMS-IMS interworking function (IWF) providing address conversion for IMS messages destined for MMS users, and providing address conversion and routing services for MMS messages destined for IMS users. The IWF performs the normal functions of a conventional Multimedia Messaging Service Center (MMSC) (for example, storing and forwarding MMS messages sent between MMS users) while also solving several problems which prevent interoperability between MMS and IMS users. For example, the logic in a conventional MMSC supports receiving an MMS message that is destined for MM1, MM3, MM4, and MM7 but not a SIP destination. Therefore, if a conventional MMSC receives an MMS message addressed to an IMS user (i.e., the TO field contains a SIP URI instead of an E.164 number), the MMSC will reject the message outright because the SIP URI is not a legal/standard MMS address. Additionally, if the prior art MMSC receives an MMS message addressed to an MMS user from an IMS user (i.e., the FROM field contains a SIP URI instead of an E.164 number), the MMSC cannot send the message to the MMS user because the MMS client in the MMS user's User Equipment (UE) does not support having a SIP URI in the FROM field of a received MMS message.

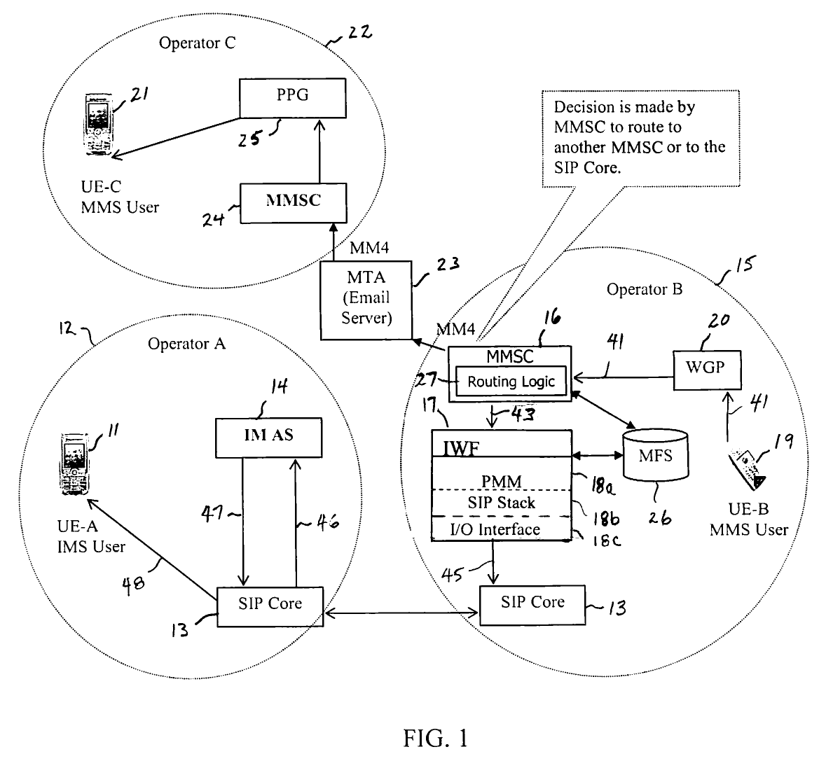

FIG. 1 is a simplified block diagram of an exemplary embodiment of the system and IWF of the present invention. An IMS user (User-A) 11 is shown within the service area of Operator-A 12. User-A communicates with a SIP Core network 13 through an access network (not shown). The SIP Core network interfaces with an Instant Messaging Application Server (IM AS) 14. The SIP Core network 13 extends into the service area of Operator-B 15 where an MMSC 16 is modified with routing logic 27, and is modified to communicate with an IWF 17, which includes a Protocol Mapping Module (PMM) 18a, a SIP Stack 18b, and an input/output (I/O) interface 18c for communicating with the SIP Core network and the MMSC. It is noted that the IWF may be co-located with the MMSC in a single node, or may be implemented separately from the MMSC. The MMSC and the IWF communicate with a Message File Store (MFS) 26. An MMS user (User-B) 19 communicates with the MMSC through a WAP Gateway 20.

For illustrative purposes, FIG. 1 also depicts a second MMS user (User-C) 21 within the service area of Operator-C 22. User-B 19 can send and receive conventional MMS messages with User-C via a Mail Transport Agent (MTA) email server 23, an MMSC 24, and a Push Proxy Gateway (PPG) 25.

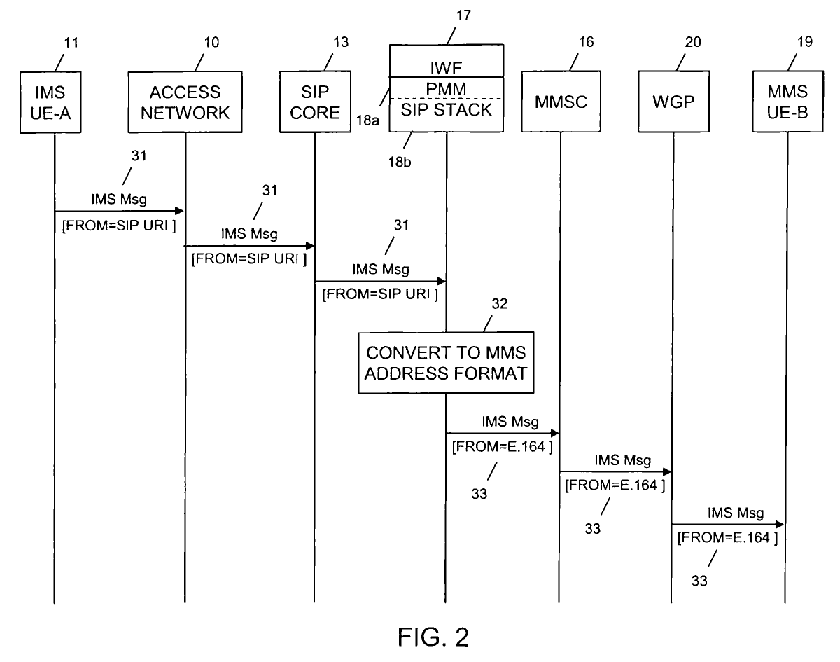

FIG. 2 is a message flow diagram illustrating the flow of messages in an exemplary embodiment of the method of the present invention. In an example scenario illustrated in FIG. 2, IMS User (UE-A) 11 sends an IMS message 31 to the MMS User (UE-B) 19. The FROM field of the header of the IMS message is formatted as a SIP URI. The IMS message travels through an access network 10 and the SIP Core network 13 to the IWF 17. At block 32, the IWF performs an address conversion by converting the message's IMS address format to an MMS address format. The IWF recognizes that the FROM field of the IMS message contains a SIP URI instead of an E.164 number, and therefore the MMSC 16 cannot send the message to the MMS user because the MMS client in UE-B does not support having a SIP URI in the FROM field of a received MMS message. The IWF obtains an E.164 number from the incoming SIP URI, which may be of the format “tel: +123456 . . . @somedomain.com” and replaces the SIP URI with the E.164 number. The modified message 33 is then sent to the MMSC 16, which then forwards the message through the WAP gateway 20 to UE-B in MMS address format.

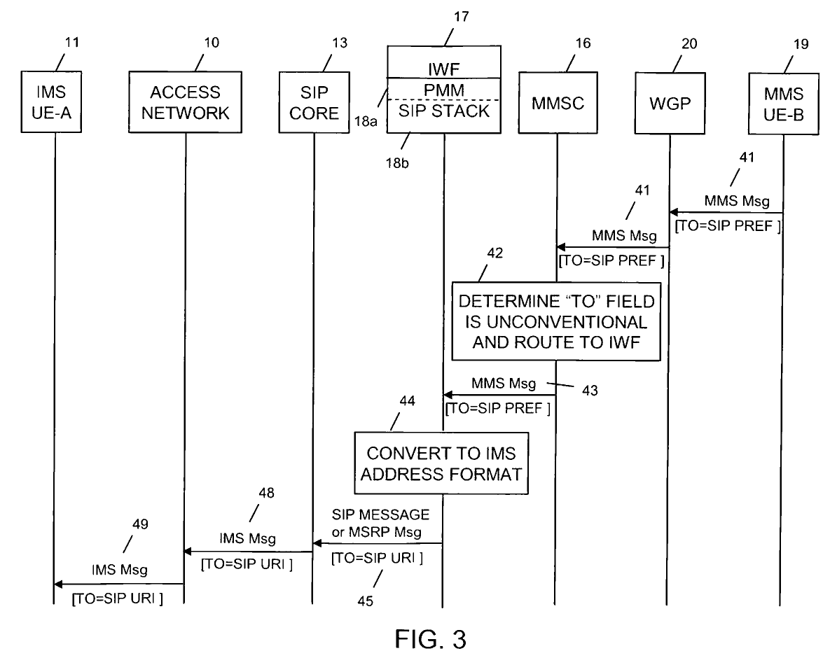

FIG. 3 is a message flow diagram illustrating the flow of messages in another exemplary embodiment of the method of the present invention. In this embodiment, also depicted by the arrows in FIG. 1, UE-B 19 desires to reply to UE-A 11 by sending back a new MMS message. This aspect of the invention may also occur as a standalone message initiated by UE-B rather than as a reply message. UE-B 19 sends an MMS message 41 through the WAP gateway 20 to the MMSC 16. The WAP Gateway receives the MMS message 31 in the WAP Encoded format and sends it to the MMSC for further processing. The content of the MMS reply message may be, for example, text and an image.

In this embodiment, UE-B 19 modifies the TO address of the MMS message from the conventional MMS format to indicate to the MMSC 16 that the message requires routing analysis. Any suitable methodology may be utilized to indicate that the message requires routing analysis. For example, a specific bit may be set as an indicator flag, or the normal MMS format may be otherwise altered. In one embodiment, the entire TO field may be put in quotes (i.e., “TO FIELD”) to indicate to the MMSC 16 that the address field is in a different format. Additionally, a “sip:” prefix may be placed in front of UE-A's address to tell the MMSC that the address is actually a SIP URI. In this case, the routing logic 27 in the MMSC routes the message to the IWF 17 where it is converted for transport through the SIP Core network 13. It should be noted that the address identifier that comes after the “sip:” prefix may be an E.164 number (i.e., 0015143457900) or string alias address such as “jojo”.

For example, the MMS TO field may read:
“sip:usera@domain1.com/TYPE=PLMN”

Alternatively the MMS TO field may read:
“sip:usera”@domain1.com, where “usera” is any legal IMS alias or name.

The MMS FROM field may read:
+5143457900/TYPE=PLMN.

When the MMSC receives the MMS message 41, the routing logic 27 in the MMSC determines the proper message routing. The MMSC stores the MMS message in the MFS 26 and attempts to perform an address resolution on the TO address field. If a conventional MMS message is received (i.e., an MMS message addressed to another MMS user), the MMSC will route the message to the MTA 23 (FIG. 1) for further routing to the destination user. However, if the message is distinguished as being unconventional (i.e. addressed to an IMS user), the MMSC will route the message to the IWF 17 at block 42.

The MMSC is modified in this embodiment of the present invention to recognize that the TO field contains an address field that is encapsulated in quotes and also begins with the “sip:” prefix. Therefore, the MMSC 16 detects that the message is not destined for an MMS user, but rather for an IMS user, and selects the SIP route to send the message. The modified MMSC automatically stops any further address analysis and at step 43 passes the MMS reply message to the IWF 17. The IWF removes the quotes from the TO field, and removes the “/TYPE=PLMN” from the TO field, if present. At block 44, logic in the PMM 18a then utilizes the SIP Stack 18b to decompose the MMS message and perform header mapping from the MMS format to either SIP MESSAGE or Message Session Relay Protocol (MSRP) format. The selected format depends on the size of the overall message received. If the message is 1300 bytes or less, then the SIP MESSAGE format may be utilized. If the message is more than 1300 bytes, MSRP may be the selected format.

The IWF 17 sends the SIP MESSAGE or MSRP formatted message 45 to the SIP Core network 13. Once the message is successfully sent, the IWF 17 receives a 200 OK or 202 ACCEPTED message in response (not shown). The IWF informs the MMSC 16, which removes the message from the MFS 26. The SIP Core network receives the SIP MESSAGE or MSRP formatted message and utilizes the TO address field (or the Request-URI) to route the message internally to the proper Call State Control Function (CSCF) for UE-A 11. In this case, Operator-A's CSCF (not shown) receives the message. At step 46 (FIG. 1), Operator-A's CSCF within the SIP Core network automatically sends the message up to the IM AS 14 for further processing. The IM AS analyzes the TO field and recognizes that the message destination is a local IMS user (i.e., UE-A) 11. Therefore, at step 47, the IM AS converts the message to an IMS message by initiating a new SIP MESSAGE or MSRP-formatted IMS message 48 addressed to UE-A, and sends the new IMS message back to Operator-A's CSCF within the SIP Core network. At 49, the SIP Core network sends the new IMS message via the access network 10 to UE-A.

Thus, to enable MMS to IMS redirection, specifically in a reply scenario, the present invention introduces several new features in the MMSC 16. The invention masquerades the FROM field to contain a SIP URI instead of an E.164 number for the purposes of routing back to the IMS user. The invention also introduces the IWF 17, with its PMM 18a and SIP Stack 18b (which may be implemented in the MMSC or separately) to enable routing to the SIP Core network 13 in addition to the existing interfaces. The invention also introduces logic in the MMSC to properly route a received MMS message based on the recipient's TO field. For example, the existing functionality may be extended so that when the MMSC receives an MMS message that has a TO field in the format “sip:user@domain.com”, the MMSC recognizes that this is an IMS user and routes the call to the SIP Core network.

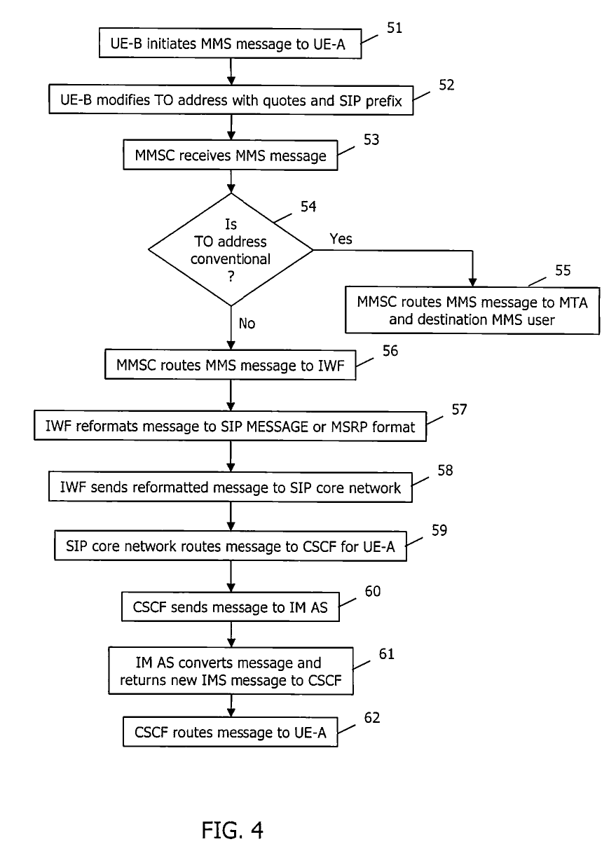

FIG. 4 is a flow chart illustrating the steps of an exemplary embodiment of the method of the present invention. At step 51, UE-B 19 initiates an MMS message destined for UE-A 11. At step 52, UE-B modifies the TO address of the MMS message from the conventional MMS format (for example, with quotes around the entire field and a SIP prefix) to indicate to the MMSC 16 that the message requires routing analysis. The MMSC receives the MMS message at step 53, and at step 54 determines whether the TO address is in conventional MMS format. If so, the method moves to step 55 where the MMSC routes the MMS message to the MTA 23 and a destination MMS user. If the MMSC determines that the TO address is not in conventional MMS format, the method moves to step 56 where the MMSC routes the MMS message to the IWF 17.

At step 57, the IWF 17 reformats the MMS message to SIP MESSAGE or MSRP format, and at step 58 sends the reformatted message to the SIP core network 13. At step 59, the step core network routes the reformatted message to the CSCF for UE-A 11. At step 60, the CSCF sends the message to the IM AS 14. At step 61, the IM AS converts the message and creates a new IMS message and returns it to the CSCF. At step 62, the CSCF routes the IMS message to UE-A.

In this embodiment, all message header conversions (IMS to MMS, MMS to IMS, and the like) take place in the IWF 17, under the control of the MMSC 16. This means that the MMSC controls the routing and the address conversion functions of all MMS messages originating within the service area of Operator-B 15. Conventional MMS messages destined for other MMS users are routed to the MTA 23 while unconventional MMS messages are routed to the IWF 17.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A system for providing interoperability between the Multimedia Messaging Service (MMS) and the IP Multimedia Subsystem (IMS), said system comprising:
logic within a multimedia messaging service center for determining whether a received MMS message includes an indication that the MMS message is destined for an IMS user;
routing logic within the multimedia messaging service center for selectively routing the MMS message to either an email server or an interworking function, wherein the MMS message is routed to the email server if the MMS message does not include an indication that the MMS message is destined for an IMS user, and the MMS message is routed to the interworking function if the MMS message includes an indication that the MMS message is destined for an IMS user;
logic within the interworking function for converting a destination address in the MMS message to a destination address for the IMS user that is routable through a Session Initiation Protocol (SIP) core network; and
an output interface for sending the converted MMS message to the SIP core network for routing to the IMS user.

2. The system according to claim 1, wherein the interworking function is implemented with the multimedia messaging service center in a single node.

3. The system according to claim 1, wherein the interworking function is implemented in a separate node in communication with the multimedia messaging service center.

4. The system according to claim 1, wherein the logic for determining whether a received MMS message includes an indication that the MMS message is destined for an IMS user includes logic for detecting quotes around a TO field of the received MMS message and for detecting a Session Initiation Protocol (SIP) prefix prior to a destination address in the TO field of the received MMS message, wherein the SIP prefix indicates the MMS message is addressed to the IMS user.

5. The system according to claim 4, wherein the routing means includes means for selectively mapping the MMS message to either a SIP MESSAGE format or a Message Session Relay Protocol (MSRP) format when the MMS message is routed to the SIP core network.

6. The system according to claim 1, wherein the logic for determining whether a received MMS message includes an indication that the MMS message is destined for an IMS user includes logic for detecting an indication that the destination address is not in standard MMS format.

7. The system according to claim 1, wherein the interworking function also includes:
an input interface for receiving through the SIP core network, an IMS message destined for an MMS user;
mapping logic for converting a source address of the received IMS message from a SIP address to an MMS address; and
a second output interface for sending the converted IMS message to the multimedia messaging service center for forwarding to the MMS user.

8. A method of interfacing the Multimedia Messaging Service (MMS) and the IP Multimedia Subsystem (IMS), said method comprising:
determining within a multimedia messaging service center whether a received MMS message includes an indication that the MMS message is destined for an IMS user;
selectively routing the MMS message from the multimedia messaging service center to either an email server or an interworking function, wherein the MMS message is routed to the email server if the MMS message does not include an indication that the MMS message is destined for an IMS user, and the MMS message is routed to the interworking function if the MMS message includes an indication that the MMS message is destined for an IMS user;
converting by the interworking function, a destination address in the MMS message to a destination address for the IMS user that is routable through a Session Initiation Protocol (SIP) core network; and
sending the converted MMS message from the interworking function to the SIP core network for routing to the IMS user.

9. The method according to claim 8, wherein the step of determining whether a received MMS message includes an indication that the MMS message is destined for an IMS user includes the step of detecting a Session Initiation Protocol (SIP) prefix prior to a destination address in a TO field of the received MMS message, wherein the SIP prefix indicates the MMS message is addressed to a destination IMS user.

10. The method according to claim 9, further comprising, before the step of detecting the SIP prefix, the step of detecting an indication that the destination address is not in standard MMS format.

11. The method according to claim 9, wherein the step of converting a destination address in the MMS message to a destination address for the IMS user that is routable through the SIP core network includes the step of selectively mapping the MMS message to either a SIP MESSAGE format or a Message Session Relay Protocol (MSRP) format.

12. The method according to claim 8, further comprising:
receiving by the interworking function, an IMS message through the SIP core network destined for an MMS user;
converting by the interworking function, a source address of the received IMS message from a SIP address to an MMS address; and
sending the converted IMS message from the interworking function to the multimedia messaging service center for forwarding to the MMS user.

13. A multimedia messaging service center for providing seamless communications between Multimedia Messaging Service (MMS) users and IP Multimedia Subsystem (IMS) users, said multimedia messaging service center comprising:
address resolution logic for determining whether a received MMS message is addressed to a destination MMS user or a destination IMS user; and
routing logic for selectively routing the MMS message to the destination MMS user or the destination IMS user based on a determination by the address resolution logic.

14. The multimedia messaging service center according to claim 13, wherein the address resolution logic includes logic for detecting a Session Initiation Protocol (SIP) prefix prior to a destination address in a TO field of the received MMS message, wherein the SIP prefix indicates the MMS message is addressed to a destination IMS user.

15. The multimedia messaging service center according to claim 14, wherein the logic for detecting the SIP prefix includes logic for detecting an indication that the destination address is not in standard MMS format.

16. The multimedia messaging service center according to claim 14, wherein the routing logic is adapted to route the MMS message to a SIP core network when the address resolution logic detects the SIP prefix.

17. The multimedia messaging service center according to claim 16, wherein the routing logic includes logic for selectively mapping the MMS message to either a SIP MESSAGE format or a Message Session Relay Protocol (MSRP) format when the MMS message is routed to the SIP core network.

18. The multimedia messaging service center according to claim 3, further comprising:
means for receiving an IMS message through the SIP core network destined for an MMS user;
logic for converting a source address of the received IMS message from a SIP address to an MMS address; and
message sending means for sending the converted IMS message to the MMS user.
